(19) United States
(12) Patent Application Publication
(10) Pub. No.: US 2025/0367887 A1
(43) Pub. Date: Dec. 4, 2025

(54) BLADE INSERT AND CUTTING ASSEMBLY

(71) Applicant: Altria Client Services LLC, Richmond, VA (US)

(72) Inventors: Dwight David WILLIAMS, Powhatan, VA (US); Charles David HOWE, Crewe, VA (US)

(73) Assignee: Altria Client Services LLC, Richmond, VA (US)

(21) Appl. No.: 19/223,861

(22) Filed: May 30, 2025

Related U.S. Application Data
(60) Provisional application No. 63/653,525, filed on May 30, 2024.

(51) Int. Cl. B29C 65/74; A24B 13/00; B29C 65/00; B29C 65/02; B29L 31/00

(52) U.S. Cl. CPC B29C 65/745; A24B 13/00; B29C 65/02; B29C 66/43121; B29L 2031/7128

(57) ABSTRACT

An apparatus for cutting and sealing a pouch includes a first housing, a blade holder, and a second housing. The first housing includes a first base wall, a first sidewall, and a second sidewall. The first sidewall and the second sidewall extend from respective ends of the first base and define a first gap. The blade holder is configured to be inserted into the first gap of the first housing and hold a blade. The blade holder is configured to move between a retracted position and an extended position. The second housing includes a second base wall, a third sidewall, and a fourth sidewall extending from respective ends of the second base wall and defining a second gap. The first sidewall is parallel to the second sidewall and the first sidewall and the second sidewall are perpendicular to the first base wall.

### CROSS-REFERENCE TO RELATED APPLICATIONS

This application claims the benefit of U.S. Provisional Application No. 63/653,525 filed on May 30, 2024, the entire disclosure of which is incorporated herein by reference in its entirety.

### BACKGROUND

### Field

The present disclosure relates to a blade insert and cutting assembly.

### SUMMARY

At least one example embodiment relates to an apparatus for cutting and sealing a pouch. In at least one example embodiment, the apparatus comprises a first housing including a first base wall, a first sidewall, and a second sidewall. The first sidewall and the second sidewall extend from respective ends of the first base wall such that the first base wall, the first sidewall, and the second sidewall define a first gap. The apparatus also comprises a blade holder configured to be inserted into the first gap of the first housing and hold a blade. The blade holder is configured to move between a retracted position and an extended position. The apparatus further comprises a second housing including a second base wall, a third sidewall, and a fourth sidewall extending from respective ends of the second base wall such that the second base wall, the third sidewall, and the fourth sidewall define a second gap.

In at least one example embodiment, the first sidewall is parallel to the second sidewall and the first sidewall and the second sidewall are perpendicular to the first base wall.

In at least one example embodiment, the second housing extends from a first end to a second end, an end of the third sidewall opposite the second base wall extends at an angle relative to a longitudinal axis, and an end of the fourth sidewall opposite the second base wall extends at the angle. In at least one example embodiment, the angle is 5°.

In at least one example embodiment, the first base wall defines a cavity extending through the first base wall to the first gap. The cavity is configured to receive a plunger. The plunger is configured to move the blade between the extended position and the retracted position. In at least one example embodiment, the plunger includes a pneumatic cylinder.

In at least one example embodiment, the apparatus further comprises a first heater coupled to the first housing, and a second heater coupled to the second housing. The first housing further comprises a first extension member extending from at least a portion of an end of the first sidewall opposite the first base wall, and a second extension member extending from at least a portion of an end of the second sidewall opposite the first base wall. In at least one example embodiment, the first housing extends from a first end to a second end, an end of the first extension extends toward the second end at an angle relative to a longitudinal axis, and an end of the second extension extends toward the second end at the angle. The angle is 5°.

In at least one example embodiment, the second housing further comprises a first extension blade extending from a least a portion of an interior surface of the third sidewall, and a second extension blade extending from a least a portion of an interior surface of the fourth sidewall. In at least one example embodiment, an end of the first extension blade curves toward the interior surface of the third sidewall, and an end of the second extension blade curves toward an interior surface of the fourth sidewall.

At least one example embodiment relates to a system for cutting and sealing a pouch. In at least one example embodiment, the system comprises a first housing, a blade holder, and a second housing. The first housing includes a first base wall, a first sidewall, and a second sidewall. The first sidewall and the second sidewall extend from respective ends of the first base wall such that the first base wall, the first sidewall, and the second sidewall define a first gap. The blade holder is configured to be inserted into the first gap of the first housing and hold a blade. The blade holder is configured to move between a retracted position and an extended position. The second housing includes a second base wall, a third sidewall, and a fourth sidewall extending from respective ends of the second base wall such that the second base wall, the third sidewall, and the fourth sidewall define a second gap. The system also includes a first jaw configured to move the first housing between a first position and a second position, a second jaw configured to move the first housing between a first position and a second position, a first heater coupled to the first jaw, the first heater configured to heat the first housing, and a second heater coupled to the second jaw, the second heater configured to heat the second housing.

In at least one example embodiment, the blade is configured to slice a pouch from a first end to a second as the first jaw and the second jaw move from the first position to the second position.

In at least one example embodiment, the first heater is configured to heat the first housing and the second heater is configured to heat the second housing such that the first housing and the second housing seal the pouch when the first jaw and the second jaw are in the second position.

In at least one example embodiment, the first sidewall is parallel to the second sidewall, and the first sidewall and the second sidewall are perpendicular to the first base wall.

In at least one example embodiment, the first housing extends from a first end to a second end, an end of the first sidewall opposite the first base wall extends from the first end to the second end at an angle relative to a longitudinal axis, and an end of the second sidewall opposite the first base wall extends from the first end to the second end at the angle. In at least one example embodiment, the angle is 5°.

In at least one example embodiment, the second housing extends from a first end to a second end, an end of the third sidewall opposite the second base wall extends at an angle relative to a longitudinal axis, and an end of the fourth sidewall opposite the second base wall extends at the angle. In at least one example embodiment, the angle is 5°.

In at least one example embodiment, the first base wall defines a cavity extending through the first base wall to the first gap. The cavity is configured to receive a plunger. The plunger is configured to move the blade between the extended position and the retracted position. In at least one example embodiment, the plunger includes a pneumatic cylinder.

In at least one example embodiment, the system further comprises a first heater coupled to the first housing, and a second heater coupled to the second housing.

In at least one example embodiment, the first housing further comprises a first extension member extending from at least a portion of an end of the first sidewall opposite the first base wall, and a second extension member extending from at least a portion of an end of the second sidewall opposite the first base wall.

In at least one example embodiment, the second housing further comprises a first extension blade extending from a least a portion of an interior surface of the third sidewall, and a second extension blade extending from a least a portion of an interior surface of the fourth sidewall.

In at least one example embodiment, an end of the first extension blade curves toward the interior surface of the third sidewall, and an end of the second extension blade curves toward an interior surface of the fourth sidewall.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a front perspective view of a cutting assembly according to at least one example embodiment.

FIG. 2 is an exploded view of a first housing, a blade holder, a blade, and a second housing of the cutting assembly of FIG. 1 according to at least one example embodiment.

FIG. 3 is a perspective view of a blade assembly according to at least one example embodiment.

FIG. 4A is a front perspective view of the first housing of FIG. 1 according to at least one example embodiment.

FIG. 4B is a front view of the first housing of FIG. 1 according to at least one example embodiment.

FIG. 4C is a side view of the first housing of FIG. 1 according to at least one example embodiment.

FIG. 4D is a bottom perspective view of the first housing of FIG. 1 according to at least one example embodiment.

FIG. 5A is front perspective view of the second housing of FIG. 1 according to at least one example embodiment.

FIG. 5B is a bottom perspective view of the second housing of FIG. 1 according to at least one example embodiment.

FIG. 5C is a front view of the second housing of FIG. 1 according to at least one example embodiment.

FIG. 6 is a detailed sectional view of the cutting assembly of FIG. 1 along line VI-VI in a retracted position according to at least one example embodiment.

FIG. 7 is a detailed sectional view of the cutting assembly of FIG. 1 along line VI-VI in a protracted position according to at least one example embodiment.

FIG. 8A is a front view of a pouching apparatus according to at least one example embodiment.

FIG. 8B is a detailed perspective view of a cutting system of the pouching apparatus of FIG. 8A according to at least one example embodiment.

### DETAILED DESCRIPTION OF EXAMPLE EMBODIMENTS

Some detailed example embodiments are disclosed herein. However, specific structural and functional details disclosed herein are merely representative for purposes of describing some example embodiments. Example embodiments may, however, be embodied in many alternate forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit an example embodiment to the particular forms disclosed, but to the contrary, example embodiments are to cover all modifications, equivalents, and alternatives falling within the scope of an example embodiment. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiment.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiment only and is not intended to be limiting of example embodiment. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

Example embodiments are described herein with reference to cross-sectional illustrations that are schematic illustrations of example embodiment. As such, variations from the shapes of the illustrations are to be expected. Thus, example embodiment should not be construed as limited to the shapes of regions illustrated herein but are to include deviations and variations in shapes.

When the words “about” and “substantially” are used in this specification in connection with a numerical value, it is intended that the associated numerical value include a tolerance of +10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., +10%) around the stated numerical values or shapes.

Unless otherwise defined, all terms (including technical and scientific terms) used herein have the same meaning as commonly understood by one of ordinary skill in the art to which example embodiment belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The present application generally relates to an apparatus for forming oral products, and more specifically, to oral pouch products. Oral pouch products are configured to be received by, and to fit within, an adult consumer's mouth. An adult consumer can suck, chew, or otherwise orally manipulate oral pouch products to release materials (e.g., flavor, functional ingredients) contained therein.

In at least one example embodiment, the oral pouch product may be an oral tobacco product, an oral non-tobacco product, an oral cannabis product, or any combination thereof.

In at least one example embodiment, the oral pouch product may include a tobacco extract, such as a tobacco-derived nicotine extract and/or synthetic nicotine. The oral pouch product may include the tobacco-derived nicotine extract and/or synthetic nicotine alone or in combination with a carrier. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In at least one example embodiment, the exhausted tobacco plant tissue or fibers may be treated to remove at least 25% (e.g., at least 40%, at least 50%, at least 60%, at least 70%, at least 75%, at least 80%, at least 85%, at least 90%, at least 95%) of the nicotine. The tobacco plant tissue may be, for example, washed with water or another solvent to remove the nicotine.

In at least one example embodiment, the oral pouch product may include, additionally, or alternatively, nicotine or a nicotine derivative. For example, the oral pouch product may include a complex of nicotine or a salt of nicotine. The complex of nicotine may include, for example, nicotine polacrilex. The salt of nicotine may include, for example, nitrate, monotartrate, bitartrate, bitartrate dihydrate, salicylate, sulfate or bisulfate, phosphate or acid phosphate, acetate, lactate, succinate, maleate, fumarate, gluconate, saccharate, benzoate, methanesulfonate, hydrochloride, hydrobromide, hydroiodide, or any combination thereof.

In at least one example embodiment, the oral pouch product may include, additionally, or alternatively, a synthetic nicotine, a nicotine alternative, or a combination of the synthetic nicotine and the nicotine alternative. The nicotine alternative may include, for example, metatine.

In at least one example embodiment, the oral pouch product may include the nicotine or nicotine derivative in an amount greater than or equal to about 0.1 milligram (e.g., greater than or equal to about 1 milligram, greater than or equal to about 2 milligrams, greater than or equal to about 4 milligrams, greater than or equal to about 6 milligrams, greater than or equal to about 8 milligrams, greater than or equal to about 10 milligrams, or greater than or equal to about 12 milligrams).

In at least one example embodiment, the oral pouch product may include the nicotine or nicotine derivative in an amount less than or equal to about 14 milligrams (e.g., less than or equal to about 12 milligrams, less than or equal to about 10 milligrams, less than or equal to about 8 milligrams, less than or equal to about 6 milligrams, less than or equal to about 4 milligrams, less than or equal to about 2 milligrams, or less than or equal to about 1 milligram).

In at least one example embodiment, the oral pouch product may include the nicotine or nicotine derivative in an amount ranging from about 3 milligrams to about 8 milligrams.

In at least one example embodiment, the oral pouch product may include, additionally, or alternatively, cannabis, such as cannabis plant tissue and/or cannabis extracts. The cannabis material may include, for example, leaf and/or flower material from one or more species of cannabis plants and/or extracts from the one or more species of cannabis plants. The one or more species of cannabis plants may include Cannabis sativa, Cannabis indica, and/or Cannabis ruderalis. In at least one example embodiment, the cannabis may be in the form of fibers. In at least one example embodiment, the cannabis may include a cannabinoid, a terpene, and/or a flavonoid. In at least one example embodiment, the cannabis material may be a cannabis-derived cannabis material, such as a cannabis-derived cannabinoid, a cannabis-derived terpene, and/or a cannabis-derived flavonoid.

In at least one example embodiment, oral pouch product may further include one or more elements such as a mouth-stable polymer, a mouth-soluble polymer, a sweetener (e.g., a synthetic sweetener, a natural sweetener, or a combination the synthetic sweetener and the natural sweetener), an energizing agent, a focusing agent (e.g., gingko biloba), a plasticizer, mouth-soluble or partially-soluble fibers (e.g., sugar beet fibers), an alkaloid, a mineral, a vitamin, a dietary supplement, a nutraceutical, a coloring agent, an amino acid, a chemesthetic agent, an antioxidant, a food-grade emulsifier, a pH modifier, a botanical (e.g., green tea), a tooth-whitening agent (e.g., sodium hexametaphosphate (SHMP)), a therapeutic agent, a processing aid, a stearate (e.g., magnesium, potassium, or a combination of magnesium and potassium), a wax (e.g., glycerol monostearate, propylene glycol monostearate, an acetylated monoglyceride, or any combination thereof), a stabilizer (e.g., ascorbic acid, monosterol citrate, butylated hydroxytoluene (BHT), butylated hydroxyanisole (BHA), or any combination thereof), a lubricant (e.g., sodium lauryl sulfate (SLS)), a disintegrating agent, a lubricant, a preservative (e.g., sodium benzoate), a filler, a flavorant, an effervescent (e.g., carbon dioxide embedded in a flavorant or a filling material), flavor masking agents, a bitterness receptor site blocker, a receptor site enhancers, nutraceuticals, other additives, or any combination thereof. The oral pouch product may include multiple additional elements. Additionally, a single element may belong to more than one of the categories above.

The oral pouch product may be an oral pouch product having, for example only, a generally rectangular shape, a ravioli or pillow shape, an oblong shape, or any other suitable shape. Various shapes may be utilized so long as the shapes fit comfortably and discreetly in an adult consumer's mouth. In at least one example embodiment, the oral pouch product is substantially free of oral cavity irritant, which, as used herein, means that the shape, configuration, and position of the oral pouch product do not irritate oral tissues (e.g., gums) via sharp edges and the like. Furthermore, “substantial” and “substantially free” as used in connection with oral cavity irritant means that the shape, configuration, and position of the oral pouch product does not irritate oral tissues (e.g., gums) in a time frame or period having the same order of magnitude as a typical length of time during which the oral pouch product may be enjoyed by an adult consumer. Generally, sharp corners are avoided as sharp corners may lead to oral discomfort.

The oral pouch product may be sized and configured to fit comfortably in an adult consumer's mouth, such as between the cheek and gum.

In at least one example embodiment, the oral pouch product may have a major dimension greater than or equal to about 0.20 inch (e.g., greater than or equal to about 0.25 inch, greater than or equal to about 0.75 inch, greater than or equal to about 1 inch, or greater than or equal to about 1.5 inch).

In at least one example embodiment, the oral pouch product may have a major dimension less than or equal to about 2.0 inches (e.g., less than or equal to about 1.5 inches, less than or equal to about 1 inches, less than or equal to about 0.75 inches, or less than or equal to about 0.25 inches).

In at least one example embodiment, the oral pouch product may have a major dimension greater than or equal to about 0.20 inch to less than or equal to about 2.0 inches (e.g., greater than or equal to about 0.25 inch to less than or equal to about 1.75 inches, greater than or equal to about 0.75 inch to less than or equal to about 1.5 inch).

In at least one example embodiment, the oral pouch product may have a transverse dimension greater than or equal to about 0.25 (e.g., greater than or equal to about 0.5 inch, greater than or equal to about 0.75 inch, or greater than or equal to about 1 inch).

In at least one example embodiment, the oral pouch product may have a transverse dimension less than or equal to about 1.5 inches (e.g., less than or equal to about 1 inches, less than or equal to about 0.75 inch, or less than or equal to about 0.5 inch)

In at least one example embodiment, the oral pouch product may have a transverse dimension greater than or equal to about 0.25 to less than or equal to about 1.5 inches (e.g., greater than or equal to about 0.50 inch to less than or equal to about 1.25 inches, greater than or equal to about 0.75 inch to less than or equal to about 1.0 inch).

In at least one example embodiment, the oral pouch product may weigh greater than or equal to about 0.25 gram (e.g., greater than or equal to about 0.3 gram, greater than or equal to about 0.4 gram, greater than or equal to about 0.5 gram, or greater than or equal to about 0.75 gram).

In at least one example embodiment, the oral pouch product may weigh less than or equal to about 2.0 grams (e.g., less than or equal to about 1.8 grams, less than or equal to about 1.5 grams, less than or equal to about 1.25 grams, or less than or equal to about 1.0 gram). For example, in certain instances, the oral pouch product may be a mini pouch.

In at least one example embodiment, the oral pouch product may weigh greater than or equal to about 0.25 gram to less than or equal to about 2.0 grams (e.g., greater than or equal to about 0.3 gram to less than or equal to about 1.8 grams, greater than or equal to about 0.4 gram to less than or equal to about 1.5 grams, greater than or equal to about 0.5 gram to less than or equal to about 1.25 grams, or greater than or equal to about 0.75 gram to less than or equal to about 1.0 gram).

In at least one example embodiment, the oral pouch product may be placed in an adult consumer's mouth for greater than or equal about 1 (e.g., greater than or equal to about 1 minute, greater than or equal to about 5 minutes, greater than or equal to about 10 minutes, or greater than or equal to about 20 minutes).

In at least one example embodiment, the oral pouch product may be placed in an adult consumer's mouth for less than or equal to about 3 hours (e.g., less than or equal to about 2 hours, less than or equal to about 90 minutes, less than or equal to about 60 minutes, or less than or equal to about 40 minutes).

In at least one example embodiment, the oral pouch product may be placed in an adult consumer's mouth for greater than or equal about 1 minute to less than or equal to about 3 hours (e.g., greater than or equal to about 1 minute to less than or equal to about 2 hours, greater than or equal to about 5 minutes to less than or equal to about 90 minutes, greater than or equal to about 10 minutes to less than or equal to about 60 minutes, or greater than or equal to about 20 minutes to less than or equal to about 40 minutes).

The size of the oral pouch product may be selected based on desired length of placement in an adult consumer's mouth. For example, a larger pouch including a larger amount of filling material may provide for longer placement.

In at least one example embodiment, the oral pouch product may be discarded after a single placement in an adult consumer's mouth.

In at least one example embodiment, the pouch wrapper includes an outer web. The outer web may be formed from a material that is generally recognized as safe (“GRAS”) for use and/or contact with food. The material may be stain resistant, water permeable, porous, or any combination thereof. The outer web can be formed of a permeable material or a semi-permeable material, such that, for example, saliva, water, or both saliva and water can pass through the outer web and into the inner cavity defined by the pouch wrapper. Flavors and juices formed by mixing saliva and/or water with the filling material contained within the oral pouch product can be drawn out of the oral pouch product through the outer web. The outer web has a desired (or alternatively, predetermined) level for basis weight and/or wet strength to reduce occurrence of breakage of the pouch wrapper during manufacturing operations, storage, and placement in an adult consumer's mouth.

In at least one example embodiment, the outer web may have an average thickness greater than or equal to about 0.05 millimeters (e.g., greater than or equal to about 0.075 millimeters, greater than or equal to about 0.1 millimeters, greater than or equal to about 0.125 millimeters, greater than or equal to about 0.15 millimeters, greater than or equal to about 0.175 millimeters, greater than or equal to about 0.2 millimeters, or greater than or equal to about 0.225 millimeters).

In at least one example embodiment, the outer web may have an average thickness less than or equal to about 0.25 millimeters (e.g., less than or equal to about 0.225 millimeters, less than or equal to about 0.2 millimeters, less than or equal to about 0.175 millimeters, less than or equal to about 0.15 millimeters, less than or equal to about 0.125 millimeters, less than or equal to about 0.1 millimeters, of less than or equal to about 0.075 millimeters).

In at least one example embodiment, the outer web may have an average thickness greater than or equal to about 0.05 millimeters to less than or equal to about 0.25 millimeters (e.g., greater than or equal to about 0.075 millimeters to less than or equal to about 0.1 millimeters or greater than or equal to about 0.1 millimeters to less than or equal to about 0.2 millimeters).

In at least one example embodiment, the pouch wrapper land/or outer web includes a woven material, a non-woven material, or a combination of the woven material and the non-woven material.

In at least one example embodiment, the pouch wrapper and/or outer web includes a polymer. The polymer may include synthetic polymers, natural polymers, or a combination of synthetic polymers and natural polymers.

In at least one example embodiment, the pouch wrapper and/or outer web may include a mesh material. The mesh material may be formed of spun or melt-blown fibers, such as polyurethane fibers, as described in U.S. Pat. Nos. 10,448,669, 10,463,070, and 9,414,624, the entire disclosures of each of which are incorporated herein by reference thereto.

In at least one example embodiment, the mesh material may be at least partially elastomeric.

In at least one example embodiment, the mesh material may be white and may exclude any colorant. In other example embodiments, the mesh material may include a colorant. The colorant may signify the contents of the pouch product. For example, a green pouch may indicate that the pouch product includes menthol while a brown pouch may indicate that the pouch product includes tobacco.

In at least one example embodiment, the mesh material may have a basis weight of greater than or equal to about 10 grams per square meter (e.g., greater than or equal to about 15 grams per square meter, greater than or equal to about 20 grams per square meter, greater than or equal to about 25 grams per square meter, greater than or equal to about 30 grams per square meter, greater than or equal to about 35 grams per square meter, greater than or equal to about 40 grams per square meter, or greater than or equal to about 45 grams per square meter).

In at least one example embodiment, the mesh material may have a basis weight of less than or equal to about 50 grams per square meter (e.g., less than or equal to about 45 grams per square meter, less than or equal to about 40 grams per square meter, less than or equal to about 35 grams per square meter, less than or equal to about 30 grams per square meter, less than or equal to about 25 grams per square meter, less than or equal to about 20 grams per square meter, or less than or equal to about 15 grams per square meter).

In at least one example embodiment, the mesh material may have a basis weight of greater than or equal to about 10 grams per square meter to less than or equal to about 50 grams per square meter (e.g., greater than or equal to about 20 grams per square meter to less than or equal to about 30 grams per square meter).

In at least one example embodiment, the pouch wrapper and/or outer web includes paper. For example, the pouch wrapper and/or outer web can be formed of a cellulose fiber material, such as tea bag material or other materials typically used to form snus pouches. In at least one example embodiment, the pouch wrapper and/or outer web may comprise a tea bag material having a basis weight of about 16.5 grams per square meter with a wet tensile CD strength of 68 N/m. In another example embodiment, the pouch wrapper and/or outer web may be formed of a paper having a wet MD tensile strength of about 45 N/mm to about 52 N/mm.

In at least one example embodiment, the pouch wrapper and/or outer web includes hydrophobic paper or material. In other example embodiments, the pouch wrapper and/or outer web may be treated such that the pouch wrapper and/or outer web has one or more hydrophobic surfaces.

In at least one example embodiment, the hydrophobic paper may be formed of a cellulosic material. The hydrophobic paper may be non-woven material and may include any hydrophobic materials. The hydrophobic materials may be synthetic materials, semi-synthetic materials, or a combination of synthetic materials and semi-synthetic materials. The hydrophobic materials may include, for example, viscose, rayon, lyocell, modal fibers, or any combination thereof.

In at least one example embodiment, the pouch wrapper and/or outer web is free of an added coloring agent. In at least one example embodiment, the pouch wrapper and/or outer web is white due to a natural color of a polymer used to form the pouch wrapper and/or outer web. However, in other example embodiments, the pouch wrapper and/or outer web may be colored to indicate a flavor of the filling material contained therein. The color of the pouch wrapper and/or outer web may be selected to identify contents thereof. For example, a green pouch wrapper may be used to identify an oral pouch product including a mint flavorant, while a red pouch wrapper may be used to identify an oral pouch product including cinnamon.

In at least one example embodiment, the pouch wrapper and/or outer web may have a neutral or pleasant taste and/or aroma. In at least one example embodiment, the pouch wrapper and/or outer web may be impregnated and/or coated with at least one flavorant, at least one cannabis material, at least one tobacco material, at least one binder, at least one sensate or chemesthesis agent, at least one functional ingredient, at least one salivation inducing ingredient, or any combination thereof, for example, to enhance a flavor of the filling material contained within the oral pouch product.

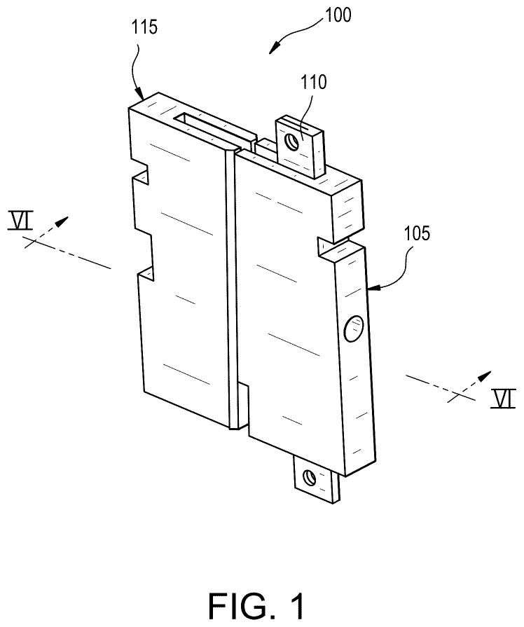

FIG. 1 is a front perspective view of a cutting assembly according to at least one example embodiment.

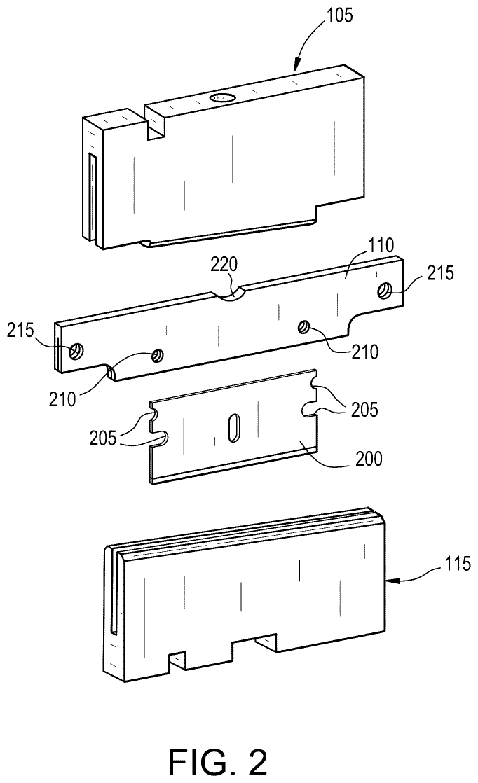

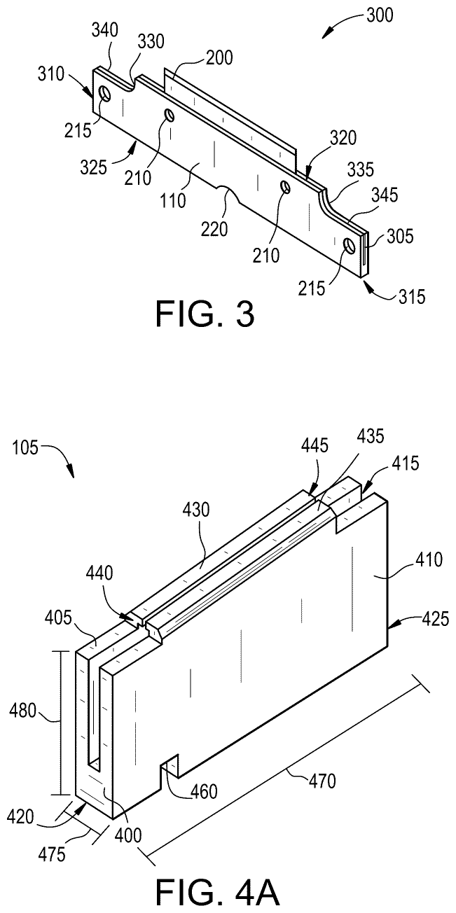

In at least one example embodiment, a cutting assembly 100 for cutting pouches is provided. The cutting assembly 100 includes a first housing 105, a blade holder 110, and a second housing 115. The blade holder 110 may be removably coupled to or positioned within the first housing 105, as will be discussed in relation to FIGS. 2-3, below. The cutting assembly 100 may be part of a pouching and/or packaging apparatus or used together with a pouching and/or packaging apparatus for oral pouch products or other pouch products. The oral pouch products may include a wrapper and a filling material. The wrapper may be formed of paper of a polymeric material, such as polyurethane. The filling material may include tobacco material, non-tobacco plant material, nicotine, caffeine, cannabis, or any other filling material.

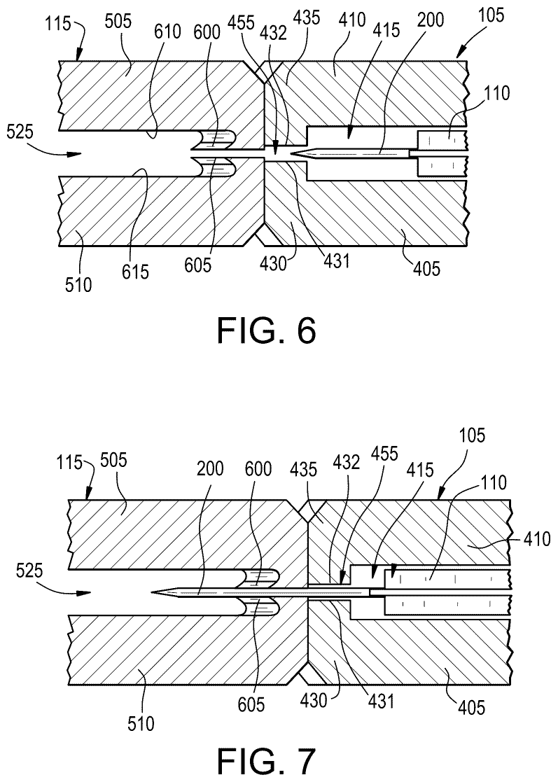

In at least one example embodiment, the cutting assembly 100 may be configured to cut and seal a pouch or package, as will be discussed in relation to FIGS. 6-8, below.

FIG. 2 is an exploded view of a first housing, a blade holder, a blade, and a second housing of the cutting assembly of FIG. 1 according to at least one example embodiment. FIG. 3 is a perspective view of a blade assembly according to at least one example embodiment.

In at least one example embodiment, the blade holder 110 is configured to receive a blade 200 and form a blade assembly 300, as shown in FIG. 3. For example, with reference to FIG. 3, the blade holder 110 may include a slot 305 configured to receive the blade 200. In at least one example embodiment, the slot 305 extends from a first end 310 to a second end 315 of the blade holder 110. The slot 305 may extend at least partially into a thickness of the of the blade holder 110. For example, the slot 305 may extend from a top side 320 toward a bottom side 325 of the blade holder 110.

In at least one example embodiment, the blade 200 may define one or more notches 205 at opposing ends of the blade 200. The one or more notches 205 may be configured to align with one or more blade holes 210 defined by the blade holder 110. In at least one example embodiment, the blade 200 may be secured within the blade holder 110 by placing one or more pins through each of the one or more blade holes 210 of the blade holder 110 and the one or more notches 205 of the blade 200.

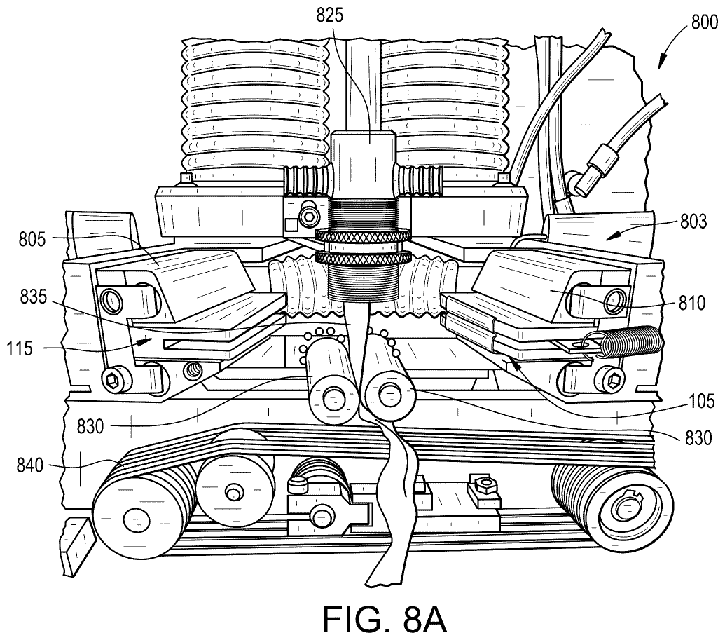

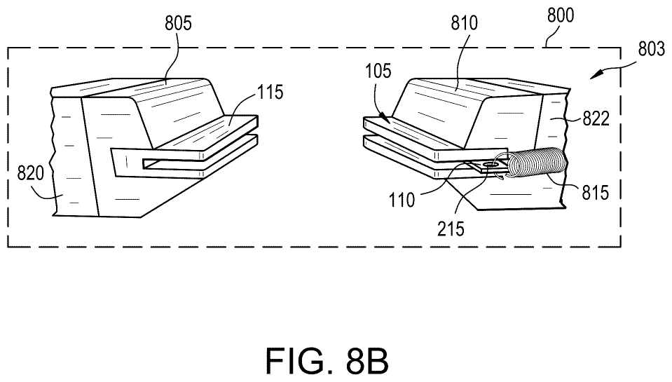

In at least one example embodiment, the blade holder 110 may define one or more attachment holes 215 on opposing ends of the blade holder 110. For example, the blade holder 110 may include one or more attachment holes 215 adjacent the first end 310 and one or more attachment holes 215 adjacent the second end 315. In at least one example embodiment, the one or more attachment holes 215 may be configured to couple the blade holder 110 to the pouching and/or packaging apparatus, as will be discussed with relation to FIG. 8, below.

In at least one example embodiment, the bottom side 325 of the blade holder 110 may define a notch 220. The notch 220 may be configured to receive at least a portion of a plunger configured to move the blade holder between a retracted and a protracted position, as will be discussed in relation to FIGS. 6-7, below.

With reference to FIG. 3, at least a portion of opposing ends of the blade holder 110 may include tapered or curved edges in at least one example embodiment. For example, the blade holder 110 may include a first curved edge 330 adjacent the first end 310 and a second curved edge 335 adjacent the second end 315. The first curved edge 330 may taper or curve from the top side 320 toward the bottom side 325 adjacent the first end 310. The second curved edge 335 may taper or curve from the top side 320 toward the bottom side 325 adjacent the second end 315. In at least one example embodiment, the blade holder 110 may include a first extension 340 extending from the first curved edge 330 to the first end 310 and a second extension 345 extending from the second curved edge 335 to the second end 315. The first extension 340 and the second extension 345 may be substantially flat. For example, the first extension 340 and the second extension 345 may be parallel with the bottom side 325 of the blade holder 110.

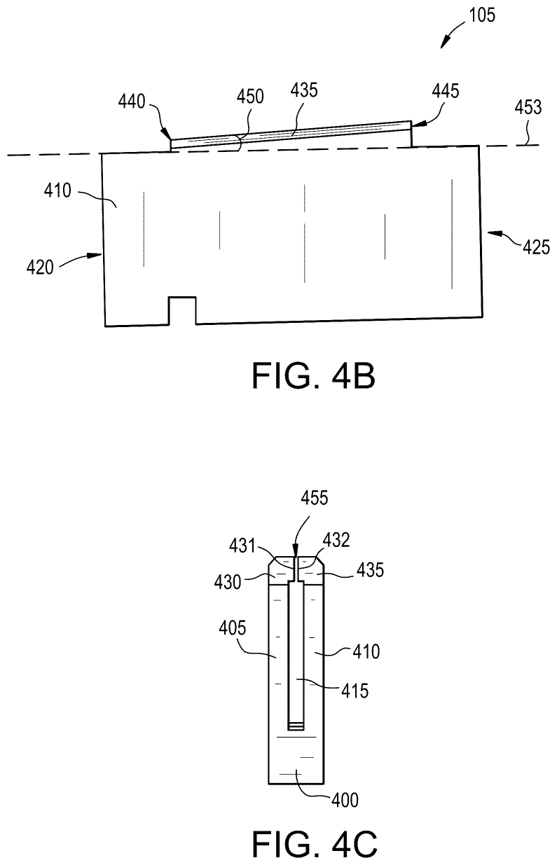

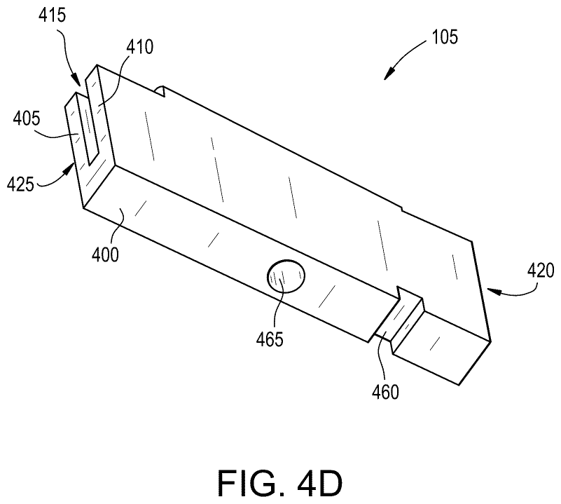

FIG. 4A is a front perspective view of the first housing of FIG. 1 according to at least one example embodiment. FIG. 4B is a front view of the first housing of FIG. 1 according to at least one example embodiment. FIG. 4C is a side view of the first housing of FIG. 1 according to at least one example embodiment. FIG. 4D is a bottom perspective view of the first housing of FIG. 1 according to at least one example embodiment.

In at least one example embodiment, the first housing 105 includes a first base wall 400, a first sidewall 405, and a second sidewall 410. The first sidewall 405 and the second sidewall 410 may extend from respective ends of the first base wall 400 such that the first sidewall 405, the first base wall 400, and the second sidewall 410 define a first gap 415. The first gap 415 may be configured to receive the blade holder 110, as shown in FIG. 1. In at least one example embodiment, the first sidewall 405 and the second sidewall 410 are parallel. In at least one example embodiment, the first sidewall 405 and the second sidewall 410 are perpendicular to the first base wall 400. In at least one example embodiment, the first housing 105 comprises a length 470 between about 40 mm and about 100 (e.g., about 45 mm to about 95 mm, about 50 mm to about 90 mm, about 55 mm to about 85 mm, about 60 mm to about 80 mm, or about 61 mm), a width 475 between about 2 mm and about 12 mm (about 4 mm to about 10 mm, about 6 mm to about 8 mm, or about 8 mm), and a height 480 between about 20 mm and about 30 mm (e.g., about 22 mm to about 28 mm, about 24 mm to about 26 mm, or about 25.5 mm).

In at least one example embodiment, the first housing 105 includes a first extension member 430 extending from at least a portion of an end of the first sidewall 405 opposite the first base wall 400 and a second extension member 435 extending from at least a portion of an end of the second sidewall 410 opposite the first base wall 400. Each of the first extension member 430 and the second extension member 435 may extend from a first side 440 adjacent a first end 420 of the first housing toward a second side 445 adjacent a second end 425 of the first housing 105. As shown in FIG. 4C, the first extension member 430 and the second extension member 435 may extend from the first side 440 to the second side 445 at an angle 450 relative to a longitudinal axis 453 extending along a length of the first housing 105. In at least one example embodiment, the angle 450 may be about 5°. In at least one example embodiment, the angle 450 may range from about 0° to about 90° (e.g., about 5° to about 85°, about 10° to about 80°, about 15° to about 75°, about 20° to about 70°, about 25° to about 65°, about 30° to about 60°, about 35° to about 55°, or about 40° to about) 50°.

In at least one example embodiment, as shown in FIG. 4C, the first extension member 430 may include a first extension 431 and the second extension member 435 may include a second extension 432. The first extension 431 and the second extension 432 may extend over the first gap 415 to define a second gap 455. In at least one example embodiment, a width of the second gap 455 is less than a width of the first gap 415. In at least one example embodiment, the width of the second gap 455 may be sized such that only the blade 200 may be configured to extend through the first gap 415 and the second gap 455 and past the first extension member 430 and the second extension member 435. For example, the first extension 431 and the second extension 432 may prevent the blade holder 110 from moving out of the first gap 415 and into the second gap 455.

In at least one example embodiment, the first base wall 400 of the first housing 105 defines at least one notch 460. The at least one notch 460 may be positioned adjacent the first end 420 of the first housing 105. In at least one other example embodiment, the at least one notch 460 may be positioned adjacent the second end 425 of the first housing 105. In at least one example embodiment, the at least one notch 460 may be configured to ensure proper alignment of the first housing 105 when attached to or inserted into a jaw of the pouching and/or packaging apparatus, as will be discussed in relation to FIG. 8, below. Further, the notch 460 may align the heater as it is assembled to the apparatus.

In at least one example embodiment, the first base wall 400 of the first housing 105 defines a cavity 465, as shown in FIG. 4D. The cavity 465 may extend through the first base wall 400 to the first gap 415. In at least one example embodiment, the cavity 465 may be configured to receive a plunger. The plunger may be configured to move the blade holder 110, along with the blade 200, between a retracted position and an extended position, as will be discussed in relation to FIGS. 6-7, below. In at least one example embodiment, the plunger may include a pneumatic cylinder.

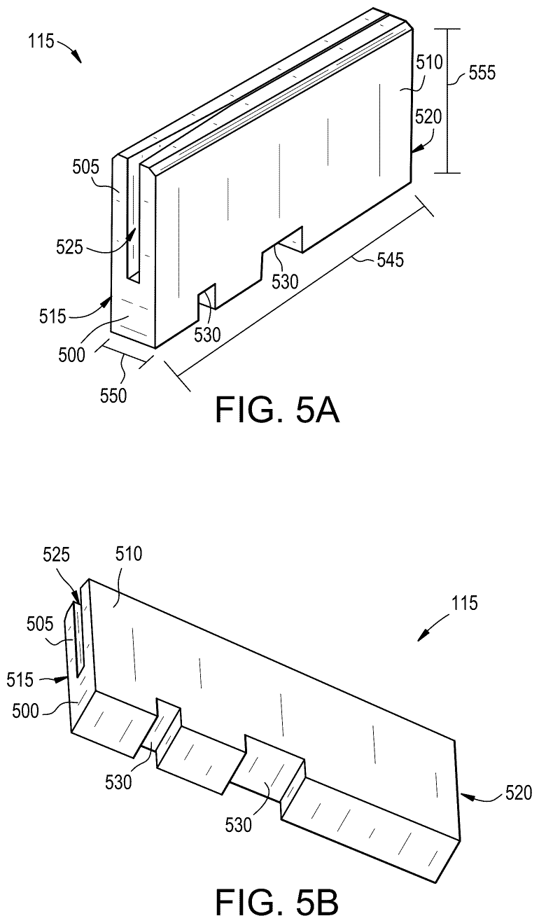

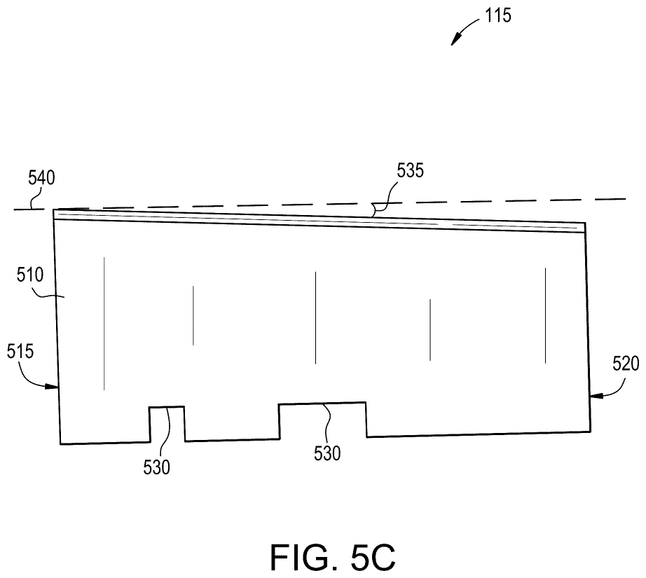

FIG. 5A is front perspective view of the second housing of FIG. 1 according to at least one example embodiment. FIG. 5B is a bottom perspective view of the second housing of FIG. 1 according to at least one example embodiment. FIG. 5C is a side view of the second housing of FIG. 1 according to at least one example embodiment.

In at least one example embodiment, the second housing 115 includes a base wall 500, a first sidewall 505, and a second sidewall 510. The first sidewall 505 and the second sidewall 510 may extend from respective ends of the base wall 500. For example, the first sidewall 505 and the second sidewall 510 may be perpendicular to the base wall 500. The first sidewall 505 and the second sidewall 510 may also be parallel. In at least one example embodiment, the base wall 500, the first sidewall 505, and the second sidewall 510 define a gap 525. The gap 525 may extend from a first end 515 to a second end 520 of the second housing 115. In at least one example embodiment, the second housing 115 comprises a length 545 between about 40 mm and about 80 mm (e.g, about 45 mm to about 75 mm, about 50 mm to about 70 mm, about 55 mm to about 65 mm or about 61 mm), a width 550 between about 2 mm and about 14 mm (e.g., about 4 mm to about 12 mm, about 6 mm to about 10 mm, or about 8 mm), and a height 555 between about 20 mm and about 30 mm (e.g., about 22 mm to about 28 mm, about 24 mm to about 26 mm or about 26 mm).

In at least one example embodiment, the base wall 500 may define one or more notches 530. The one or more notches 530 may be configured to ensure proper alignment of the second housing 115 when attached to or inserted into a jaw of the pouching and/or packaging apparatus, as will be discussed in relation to FIG. 8, below.

In at least one example embodiment, as shown in FIG. 5A, a width of the gap 525 between the first sidewall 505 and the second sidewall 510 may decrease from the first end 515 to the second end 520 of the second housing 115. For example, the width of the gap 525 adjacent the first end 515 may be greater than the width of the gap 525 adjacent the second end 520. In at least one example embodiment, at least a top portion of the first sidewall 505 and the second sidewall 510 may taper or narrow from the second end 520 toward the first end 515.

In at least one example embodiment, as shown in FIG. 5C, a top portion of the first sidewall 505 and the second sidewall 510 may extend from the first end 515 to the second end 520 at an angle 535 relative to a longitudinal axis 540. In at least one example embodiment, the angle 535 may be about 5°.

FIG. 6 is a detailed sectional view of the cutting assembly of FIG. 1 along line VI-VI in a retracted position according to at least one example embodiment. FIG. 7 is a detailed sectional view of the cutting assembly of FIG. 1 along line VI-VI in a protracted position according to at least one example embodiment.

In at least one example embodiment, the second housing 115 includes a first extension blade extending from at least a portion of an interior surface 610 of the first sidewall 505 and a second extension blade 605 extending from at least a portion of an interior surface 615 of the second sidewall 510. For example, the first extension blade 600 and the second extension blade 605 may extend from the interior surface 610 and the interior surface 615, respectively, adjacent ends of the first sidewall 505 and the second sidewall 510 opposite the base wall 500. In at least one example embodiment, the first extension blade 600 may curve toward the second sidewall 510 and into the gap 525. In at least one example embodiment, the first extension blade 600 may extend from the interior surface 610 of the first sidewall 505 and curve downward toward the base wall 500. In at least one example embodiment, the second extension blade 605 may curve toward the first sidewall 505 and into the gap 525. In at least one example embodiment, the second extension blade 605 may extend from the interior surface 615 of the second sidewall 510 and curve downward toward the base wall 500.

In at least one example embodiment, the blade holder 110 is configured to move the blade 200 between a retracted position (shown in FIG. 6) and a protracted position (shown in FIG. 7). For example, a plunger may be configured to enter the cavity 465 in the first housing 105 (shown in FIG. 4D) and move the blade holder 110, and thus the blade 200, between the retracted and protracted positions.

In at least one example embodiment, the blade 200 is configured to cut or slice a pouch material between the first housing 105 and the second housing 115 when moving from the retracted position to the protracted position. In at least one example embodiment, the blade 200 is configured to enter the gap 525 of the second housing 115 from the first end 515 due to the angle 535 of the first sidewall 505 and the second sidewall 510. In such embodiments, the blade may cut or slice the pouch material from the first ends 420, 515 of the first housing 105 and the second housing 115 toward the second ends 425, 520 of the first housing 105 and the second housing 115.

In at least one example embodiment, the first extension blade 600 and the second extension blade 605 are configured to remove any debris on the blade 200 as the blade 200 moves from the protracted position to the retracted position and exits the gap 525 of the second housing 115.

FIG. 8A is a front view of a pouching apparatus according to at least one example embodiment. FIG. 8B is a detailed, perspective view of a cutting system of the pouching apparatus of FIG. 8A according to at least one example embodiment.

The cutting assembly 100 may be part of a pouching and/or packaging apparatus or used together with a pouching and/or packaging apparatus, such as a pouching apparatus 800. In at least one example embodiment, the pouching apparatus 800 includes a guide 825 and a pair of rollers 830. The guide 825 may be configured to receive a pouch material 835 and guide the pouch material 835 through a center of the pouching apparatus 800. The pouch material 835 may comprise a continuous web or tube of a polymer material. In at least one example embodiment, the pouch material 835 may be moved through the guide by the pair of rollers 830.

In at least one example embodiment, the pouching apparatus 800 may include a cutting system 803 having a first jaw 805 configured to hold the second housing 115 and a second jaw 810 configured to hold the first housing 105. The rollers 830 are configured to move the pouch material 835 such that at least a portion of the pouch material 835 is positioned between the first jaw 805 and the second jaw 810. As shown in FIGS. 8A-8B, the first jaw 805 and the second jaw 810 may be in a first position such that the first housing 105 and the second housing 115 are separated. In the first position, a pouch material 835 may be positioned between the first housing 105 and the second housing 115. In at least one example embodiment, the pouch material 835 may be configured to be filled with at least one substance while the cutting system 803 is in the first position. In at least one example embodiment, the at least one substance is a consumer product. In at least one example embodiment, the at least one substance and/or the consumer product includes an oral product.

In at least one example embodiment, before and/or after the pouch material 835 is filled, the pouching apparatus 800 may move the first jaw 805 and the second jaw 810 towards each other to a second position. For example, the first housing 105 and the second housing 115 may be adjacent to each other or contacting each other in the second position, as shown in FIGS. 1, 6, and 7. In the second position, the blade holder 110 may move the blade 200 from the retracted position to the protracted position to cut or slice the pouch material 835, as discussed above with respect to FIGS. 6-7, and form a pouch. In at least one example embodiment, the second jaw 810 includes an opening corresponding to the cavity 465 of the first housing 105 (shown in FIG. 4D) configured to receive a plunger and move the blade holder 110, and thus the blade 200, between the retracted and protracted positions.

In at least one example embodiment, the cutting system 803 includes a spring 815 coupled to each of the attachment holes 215 of the blade holder 110. Each spring 815 is configured to be coupled to the pouching apparatus 800 and to secure the blade holder 110 within the first housing 105. Additionally, the force of the spring 815 may be overcome by the plunger to move the blade holder 110 to the protracted position (shown in FIG. 7). When the plunger is removed, the force of the spring 815 returns the blade holder 110 to the retracted position (shown in FIG. 6).

In at least one example embodiment, the cutting apparatus 800 includes at least one heater coupled to one or both of the first jaw 805 and the second jaw 810. For example, a first heater 820 may be coupled to the first jaw 805 and/or the second housing 115 and a second heater 822 may be coupled to the second jaw 810 and/or the first housing 105. The first heater 820 may be configured to apply heat to the first jaw 805 and the second housing 115 and the second heater 822 may be configured to supply heat to the second jaw 810 and the first housing 105 such that when the first jaw 805 and the second jaw 810 are in the second position, heat may be applied to the pouch material 835 to seal an end of the pouch material 835. For example, the pouch material 835 may be fed between the first jaw 805 and the second jaw 810 and the first jaw 805 and the second jaw 810 may seal the end of the pouch material 835 with or without cutting the pouch material 835 with the blade 200.

In at least one example embodiment, the first jaw 805 and the second jaw 810 may be moved to the second position, such that the first housing 105 and the second housing 115 are adjacent to each other, as shown in FIGS. 1, 6, and 7, to seal a first end of the pouch material 835 via the first heater 820 and the second heater 822 prior to filling. After sealing the first end of the pouch material 835, the first jaw 805 and the second jaw may return to the first position, shown in FIGS. 8A-8B, and the pouch material 835 may then be filled with the at least one substance. In at least one example embodiment, the pouch material 835 may be advanced downward such that a second end of the pouch material 835 is aligned with or adjacent to the first housing 105 and the second housing 115. For example, the pair of rollers 830 may guide the first end of the pouch material 835 downwards after it has been sealed and/or filled with the at least one substance. After filling, the first jaw 805 and the second jaw 810 may move to the second position such that the second end of the pouch material 835 may be cut, as discussed above with respect to FIGS. 6-7, and sealed by heat supplied from the first heater 820 and the second heater 822 to form a pouch including the at least one substance. Further, the pulling rollers 830 may be lightly spring loaded so as to put a light downward pressure on the pouch and help the pouch separate from the next pouch after cutting. As the cut pouch goes between the pulling rollers 830, the pulling rollers 830 open slightly to continue pulling without damaging the cut pouch. After the second end of the pouch is cut, the pouch including the at least one substance may be released to a conveyor, such as a conveyor 840, below the pouching apparatus 800. The exemplary process described above may be repeated to form a plurality of pouches including the at least one substance.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Although described with reference to specific examples and drawings, modifications, additions and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.
Illustrative Embodiment 1. An apparatus for cutting and sealing a pouch, comprising:
a first housing including, a first base wall, a first sidewall, and a second sidewall, the first sidewall and the second sidewall extending from respective ends of the first base wall such that the first base wall, the first sidewall, and the second sidewall define a first gap; a blade holder configured to be inserted into the first gap of the first housing and hold a blade, the blade holder configured to move between a retracted position and an extended position; and a second housing including, a second base wall, a third sidewall, and a fourth sidewall extending from respective ends of the second base wall such that the second base wall, the third sidewall, and the fourth sidewall define a second gap.
Illustrative Embodiment 2. The apparatus of illustrative embodiment 1 wherein the first sidewall is parallel to the second sidewall; and the first sidewall and the second sidewall are perpendicular to the first base wall.
Illustrative Embodiment 3. The apparatus any of illustrative embodiments 1-2, wherein the second housing extends from a first end to a second end; an end of the third sidewall opposite the second base wall extends at an angle relative to a longitudinal axis; and an end of the fourth sidewall opposite the second base wall extends at the angle.
Illustrative Embodiment 4. The apparatus of illustrative embodiment 3, wherein the angle is 5°.
Illustrative Embodiment 5. The apparatus of any of illustrative embodiments 1-4, wherein the first base wall defines a cavity extending through the first base wall to the first gap, the cavity configured to receive a plunger, the plunger configured to move the blade between the extended position and the retracted position.
Illustrative Embodiment 6. The apparatus of any of illustrative embodiments 1-5, wherein the plunger includes a pneumatic cylinder.
Illustrative Embodiment 7. The apparatus of any of illustrative embodiments 1-6, further comprising: a first heater coupled to the first housing; and a second heater coupled to the second housing.
Illustrative Embodiment 8. The apparatus of any of illustrative embodiments 1-7, wherein the first housing further comprises: a first extension member extending from at least a portion of an end of the first sidewall opposite the first base wall; and a second extension member extending from at least a portion of an end of the second sidewall opposite the first base wall.
Illustrative Embodiment 9. The apparatus of any of illustrative embodiments 1-8, wherein the first housing extends from a first end to a second end; an end of the first extension member extends toward the second end at an angle relative to a longitudinal axis; and an end of the second extension member extends toward the second end at the angle.
Illustrative Embodiment 10. The apparatus of illustrative embodiment 9, wherein the angle is 5°.
Illustrative Embodiment 11. The apparatus of any of illustrative embodiments 1-10, wherein the second housing further comprises: a first extension blade extending from a least a portion of an interior surface of the third sidewall; and a second extension blade extending from a least a portion of an interior surface of the fourth sidewall.
Illustrative Embodiment 12. The apparatus of any of illustrative embodiments 1-11, wherein: an end of the first extension blade curves toward the interior surface of the third sidewall; and an end of the second extension blade curves toward an interior surface of the fourth sidewall.
Illustrative Embodiment 13. The apparatus of any of illustrative embodiments 1-12, wherein an end of the first extension blade curves toward the interior surface of the third sidewall; and an end of the second extension blade curves toward an interior surface of the fourth sidewall.
Illustrative Embodiment 13. A system for cutting and sealing a pouch, comprising: a first housing including, a first base wall, a first sidewall, and a second sidewall, the first sidewall and the second sidewall extending from respective ends of the first base wall such that the first base wall, the first sidewall, and the second sidewall define a first gap; a blade holder configured to be inserted into the first gap of the first housing and hold a blade, the blade holder configured to move between a retracted position and an extended position; a second housing including, a second base wall, a third sidewall, and a fourth sidewall extending from respective ends of the second base wall such that the second base wall, the third sidewall, and the fourth sidewall define a second gap; a first jaw configured to move the first housing between a first position and a second position; a second jaw configured to move the first housing between a first position and a second position; a first heater coupled to the first jaw, the first heater configured to heat the first housing; and a second heater coupled to the second jaw, the second heater configured to heat the second housing.
Illustrative Embodiment 14. The system of illustrative embodiment 13, wherein the blade is configured to slice a pouch from a first end to a second as the first jaw and the second jaw move from the first position to the second position.
Illustrative Embodiment 15. The system of any of illustrative embodiments 13-14, wherein the first heater is configured to heat the first housing and the second heater is configured to heat the second housing such that the first housing and the second housing seal the pouch when the first jaw and the second jaw are in the second position.
Illustrative Embodiment 16. The system of any of illustrative embodiments 13-15, wherein the first sidewall is parallel to the second sidewall; and the first sidewall and the second sidewall are perpendicular to the first base wall.
Illustrative Embodiment 17. The system of any of illustrative embodiments 13-16, wherein the first housing extends from a first end to a second end; an end of the first sidewall opposite the first base wall extends from the first end to the second end at an angle relative to a longitudinal axis; and an end of the second sidewall opposite the first base wall extends from the first end to the second end at the angle.
Illustrative Embodiment 18. The system of illustrative embodiment 17, wherein the angle is 5°
Illustrative Embodiment 19. The system of any of illustrative embodiments 13-18, wherein the second housing extends from a first end to a second end; an end of the third sidewall opposite the second base wall extends at an angle of about 5° relative to a longitudinal axis; and an end of the fourth sidewall opposite the second base wall extends at the angle.
Illustrative Embodiment 20. The system of any of illustrative embodiments 13-19, wherein the first base wall defines a cavity extending through the first base wall to the first gap, the cavity configured to receive a plunger, the plunger configured to move the blade between the extended position and the retracted position.
Illustrative Embodiment 21. The system of any of illustrative embodiments 13-20, wherein the plunger includes a pneumatic cylinder.
Illustrative Embodiment 22. The system of any of illustrative embodiments 13-21, further comprising: a first heater coupled to the first housing; and a second heater coupled to the second housing.
Illustrative Embodiment 23. The system of any of illustrative embodiments 13-22, wherein the first housing further comprises: a first extension member extending from at least a portion of an end of the first sidewall opposite the first base wall; and a second extension member extending from at least a portion of an end of the second sidewall opposite the first base wall.
Illustrative Embodiment 24. The system of any of illustrative embodiments 13-23, wherein the second housing further comprises: a first extension blade extending from a least a portion of an interior surface of the third sidewall; and a second extension blade extending from a least a portion of an interior surface of the fourth sidewall.
Illustrative Embodiment 25. The system of any of illustrative embodiments 13-24, wherein an end of the first extension blade curves toward the interior surface of the third sidewall; and an end of the second extension blade curves toward an interior surface of the fourth sidewall.

We claim:

1. An apparatus for cutting and sealing a pouch, comprising:
a first housing including,
a first base wall,
a first sidewall, and
a second sidewall, the first sidewall and the second sidewall extending from respective ends of the first base wall such that the first base wall, the first sidewall, and the second sidewall define a first gap;
a blade holder configured to be inserted into the first gap of the first housing and hold a blade, the blade holder configured to move between a retracted position and an extended position; and
a second housing including,
a second base wall,
a third sidewall, and
a fourth sidewall extending from respective ends of the second base wall such that the second base wall, the third sidewall, and the fourth sidewall define a second gap.

2. The apparatus of claim 1, wherein
the first sidewall is parallel to the second sidewall; and
the first sidewall and the second sidewall are perpendicular to the first base wall.

3. The apparatus of claim 1, wherein:
the second housing extends from a first end to a second end;
an end of the third sidewall opposite the second base wall extends at an angle relative to a longitudinal axis;
and
an end of the fourth sidewall opposite the second base wall extends at the angle.

4. The apparatus of claim 3, wherein the angle is 5°.

5. The apparatus of claim 1, wherein the first base wall defines a cavity extending through the first base wall to the first gap, the cavity configured to receive a plunger, the plunger configured to move the blade between the extended position and the retracted position.

6. The apparatus of claim 5, wherein the plunger includes a pneumatic cylinder.

7. The apparatus of claim 1, further comprising:
a first heater coupled to the first housing; and
a second heater coupled to the second housing.

8. The apparatus of claim 1, wherein the first housing further comprises:
a first extension member extending from at least a portion of an end of the first sidewall opposite the first base wall; and
a second extension member extending from at least a portion of an end of the second sidewall opposite the first base wall.

9. The apparatus of claim 8, wherein:
the first housing extends from a first end to a second end;
an end of the first extension member extends toward the second end at an angle relative to a longitudinal axis; and
an end of the second extension member extends toward the second end at the angle.

10. The apparatus of claim 9, wherein the angle is 5°.

11. The apparatus of claim 1, wherein the second housing further comprises:
a first extension blade extending from a least a portion of an interior surface of the third sidewall; and
a second extension blade extending from a least a portion of an interior surface of the fourth sidewall.

12. The apparatus of claim 11, wherein:
an end of the first extension blade curves toward the interior surface of the third sidewall; and
an end of the second extension blade curves toward an interior surface of the fourth sidewall.

13. A system for cutting and sealing a pouch, comprising:
a first housing including,
a first base wall,
a first sidewall, and
a second sidewall, the first sidewall and the second sidewall extending from respective ends of the first base wall such that the first base wall, the first sidewall, and the second sidewall define a first gap;
a blade holder configured to be inserted into the first gap of the first housing and hold a blade, the blade holder configured to move between a retracted position and an extended position;
a second housing including,
a second base wall,
a third sidewall, and
a fourth sidewall extending from respective ends of the second base wall such that the second base wall, the third sidewall, and the fourth sidewall define a second gap;
a first jaw configured to move the first housing between a first position and a second position;
a second jaw configured to move the first housing between a first position and a second position;
a first heater coupled to the first jaw, the first heater configured to heat the first housing; and
a second heater coupled to the second jaw, the second heater configured to heat the second housing.

14. The system of claim 13, wherein
the blade is configured to slice a pouch from a first end to a second as the first jaw and the second jaw move from the first position to the second position; and
the first heater is configured to heat the first housing and the second heater is configured to heat the second housing such that the first housing and the second housing seal the pouch when the first jaw and the second jaw are in the second position.

15. The system of claim 13, wherein
the first sidewall is parallel to the second sidewall; and
the first sidewall and the second sidewall are perpendicular to the first base wall.

16. The system of claim 13, wherein:
the first housing extends from a first end to a second end;
an end of the first sidewall opposite the first base wall extends from the first end to the second end at an angle relative to a longitudinal axis;
an end of the second sidewall opposite the first base wall extends from the first end to the second end at the angle; and
the angle is 5°.

17. The system of claim 13, wherein:
the second housing extends from a first end to a second end;
an end of the third sidewall opposite the second base wall extends at an angle of about 5° relative to a longitudinal axis; and
an end of the fourth sidewall opposite the second base wall extends at the angle.

18. The system of claim 13, wherein the first base wall defines a cavity extending through the first base wall to the first gap, the cavity configured to receive a plunger, the plunger configured to move the blade between the extended position and the retracted position, and the plunger includes a pneumatic cylinder.

19. The system of claim 13, further comprising:
a first heater coupled to the first housing; and
a second heater coupled to the second housing.

20. The system of claim 13, wherein
the first housing further comprises:
a first extension member extending from at least a portion of an end of the first sidewall opposite the first base wall; and
a second extension member extending from at least a portion of an end of the second sidewall opposite the first base wall;
the second housing further comprises:
a first extension blade extending from a least a portion of an interior surface of the third sidewall; and
a second extension blade extending from a least a portion of an interior surface of the fourth sidewall,
an end of the first extension blade curves toward the interior surface of the third sidewall;
and
an end of the second extension blade curves toward an interior surface of the fourth sidewall.
